(19) United States
(12) Patent Application Publication
(10) Pub. No.: US 2025/0044165 A1
(43) Pub. Date: Feb. 6, 2025

(54) THERMISTOR

(71) Applicant: YAZAKI CORPORATION, Tokyo (JP)

(72) Inventors: Hiraku TANAKA, Shizuoka (JP); Yusuke YAMADA, Shizuoka (JP)

(73) Assignee: YAZAKI CORPORATION, Tokyo (JP)

(21) Appl. No.: 18/782,120

(22) Filed: Jul. 24, 2024

(30) Foreign Application Priority Data
Jul. 31, 2023 (JP) 2023-124123

(51) Int. Cl. G01K 7/22; H01C 1/01; H01C 1/14

(52) U.S. Cl. CPC G01K 7/226; H01C 1/01; H01C 1/14

(57) ABSTRACT

A thermistor includes: a holding member that is assembled on a wall portion of a housing member, the wall portion separating an inside and an outside of the housing member; and a thermistor body that is held by the holding member and that detects a temperature inside the housing member. The thermistor body includes: a thermistor element that detects the temperature; a lead wire that is electrically connected to the thermistor element; and a resin portion which covers the thermistor element and from which the lead wire leads to an outside portion. The holding member includes: a holding portion that holds the resin portion and arranges the thermistor element inside the housing member; and a lead-out portion that leads the lead wire to the outside of the housing member.

### CROSS-REFERENCE TO RELATED APPLICATIONS

The present application is based on, and claims priority from Japanese Patent Application No. 2023-124123, filed on Jul. 31, 2023, the entire contents of which are incorporated herein by reference.

### TECHNICAL FIELD

The present disclosure relates to a thermistor.

### BACKGROUND ART

In the past, there has been provided a thermistor including a duct mounting member as a holding member which is assembled on a wall portion separating an inside and an outside of a duct as a housing member. Further, a thermistor is known that includes a thermistor body which is held by a duct mounting member and detects a temperature inside a duct (see Patent Literature 1: JP 2023-006323 A). The thermistor body in the thermistor disclosed in Patent Literature 1 includes a thermistor element which detects a temperature, a lead wire which is electrically connected to the thermistor element, and a resin portion which is integrally provided with the lead wire to cover the lead wire. With this kind of thermistor, by assembling the resin portion to the duct mounting member, the thermistor body is assembled to the duct mounting member, and the thermistor element is arranged inside the duct.

### SUMMARY

However, in the thermistor disclosed in Patent Literature 1, the lead wire is covered with the resin portion and the resin portion is covered with the holding member while the thermistor body is assembled to the holding member. Therefore, the lead wire is doubly covered with the resin portion and the holding member, and it is difficult to transfer heat inside the housing member to the lead wire. The lead wire leads to the outside of the housing member and is easily affected by a temperature outside the housing member. If it is difficult to transfer heat inside the housing member to the lead wire, the temperature difference between the inside of the housing member and the lead wire becomes large. If the temperature difference between the inside of the housing member and the lead wire becomes large, there is a possibility of affecting a detected temperature of the thermistor element which is electrically connected to the lead wire to detect temperature, and the detection accuracy may deteriorate.

The present disclosure has been devised in view of the above mentioned problems. An object of the present disclosure is to provide a thermistor capable of enhancing detection accuracy.

A thermistor according to an embodiment includes: a holding member that is assembled on a wall portion of a housing member, the wall portion separating an inside and an outside of the housing member; and a thermistor body that is held by the holding member and that detects a temperature inside the housing member. The thermistor body includes: a thermistor element that detects the temperature; a lead wire that is electrically connected to the thermistor element; and a resin portion which covers the thermistor element and from which the lead wire leads to an outside portion. The holding member includes: a holding portion that holds the resin portion and arranges the thermistor element inside the housing member; and a lead-out portion that leads the lead wire to the outside of the housing member.

According to the embodiment, it is possible to provide the thermistor capable of enhancing detection accuracy.

### BRIEF DESCRIPTION OF THE DRAWINGS

FIG. 1 is a perspective view of a thermistor according to an embodiment.

FIG. 2 is a side view of the thermistor according to the embodiment.

FIG. 3 is a cross-sectional view of the thermistor according to the embodiment.

FIG. 4 is a perspective view of a thermistor body of the thermistor according to the embodiment.

FIG. 5 is a perspective view of a thermistor body not including a resin portion of the thermistor according to the embodiment.

### DETAILED DESCRIPTION

A thermistor according to an embodiment will be described in detail below with reference to the drawings. Note that dimensional ratios in the drawings are exaggerated for convenience of the description and may be different from actual ratios.

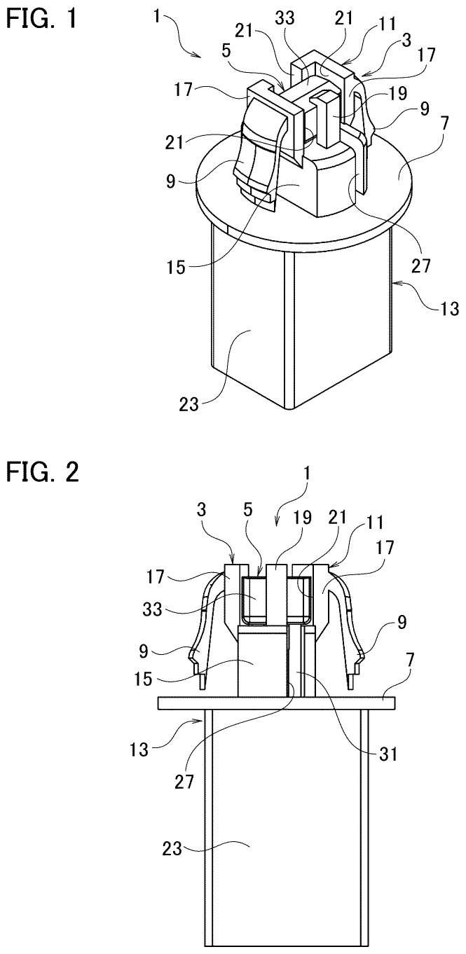

As illustrated in FIG. 1, a thermistor 1 according to an embodiment is applied to detect a temperature inside a housing member (not illustrated) such as a duct that supplies air to a battery unit mounted in a vehicle. The thermistor 1 can make the duct supply appropriate air by detecting the temperature inside the duct and can control a temperature of a battery unit, for example. By controlling the temperature of the battery unit, a traveling output from the battery unit to a vehicle can be stabilized.

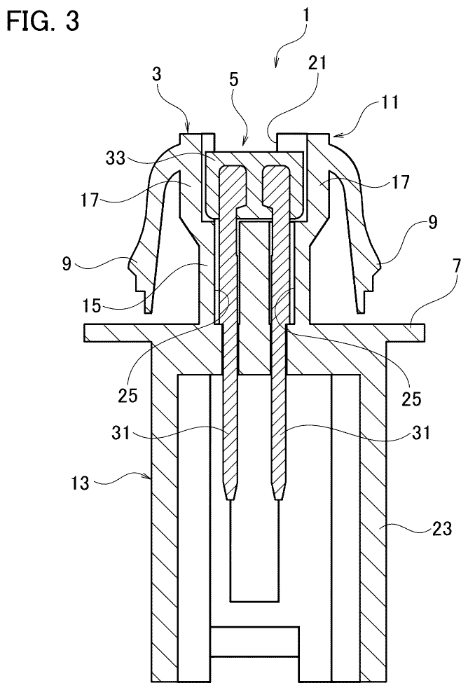

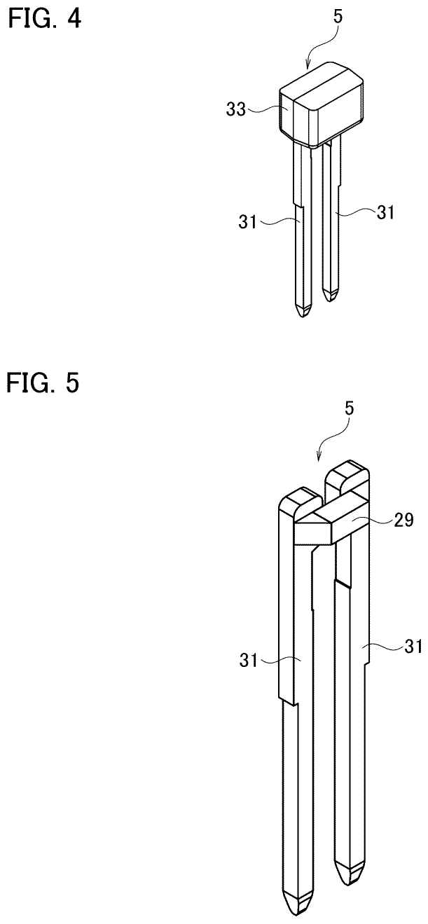

As illustrated in FIGS. 1 to 5, the thermistor 1 includes a holding member 3 and a thermistor body 5.

As illustrated in FIGS. 1 to 3, the holding member 3 is made from an insulating material such as polypropylene (PP resin), for example. The holding member 3 is formed in a tubular shape so as to extend from an inside and an outside of the housing member relative to a wall portion (not illustrated) that separates the inside and the outside of the housing member. The holding member 3 is inserted into a hole (not illustrated) formed in the wall portion of the housing member by being passed through the wall portion and assembled on the wall portion. On an outer surface of the holding member 3 arranged on the wall portion, a flange portion 7 is formed which abuts an outer surface of an external side of the wall portion. On an outer surface of the holding member 3 arranged in an internal side of the housing member, a pair of elastically deformable locking pieces 9 are formed which are engaged with an edge of the hole in the wall portion.

The holding member 3 is inserted into the hole in the wall portion of the housing member from the external side to the internal side of the housing member. At this point, the pair of locking pieces 9 are elastically deformed by being abutted on the edge of the hole, and the holding member 3 can be inserted into the hole. Continuing insertion of the holding member 3 into the hole, the flange portion 7 abuts the wall portion of the housing member, and the insertion of the holding member 3 is complete. At this point, a state of the pair of locking pieces 9 is restored from the elastic deformed state, the pair of locking pieces 9 are engaged with the edge of the hole, and the holding member 3 is assembled on the wall portion of the housing member. The holding member 3 includes a holding portion 11 and a lead-out portion 13.

The holding portion 11 is disposed at a portion in the holding member 3 which is arranged inside the housing member. The holding portion 11 is a space formed by a top surface of an insertion portion 15 extending from the flange portion 7 toward the inside of the housing member, and inner surfaces of a pair of holding walls 17 extending from the top surface side of the insertion portion 15 toward the inside of the housing member. Outer surfaces of the pair of holding walls 17 and base ends of the pair of locking pieces 9 are formed from a continuous member. The holding portion 11 houses a resin portion 33 of the thermistor body 5, which will be described later. The holding portion 11 has an elastically deformable holding piece 19 extending from a top surface of the insertion portion 15 toward the inside of the housing member. The holding piece 19 engages with the resin portion 33 while the resin portion 33 is housed in the holding portion 11, and the thermistor body 5 is held by the holding member 3. The holding portion 11 has a plurality of resin exposure portions 21 for exposing the resin portion 33 housed in the holding portion 11 to the outside. The resin exposure portions 21 are an opening between the pair of holding walls 17, an opening between the pair of holding walls 17 and the holding piece 19, and an opening on a tip side between the pair of holding walls 17 and the holding piece 19. Due to the holding portion 11 having the resin exposure portions 21, the resin portion 33 can directly contact air inside the housing member, and the temperature detection accuracy by the thermistor body 5 can be enhanced.

The lead-out portion 13 is disposed at a portion in the holding member 3 which is arranged inside and outside the housing member. The lead-out portion 13 includes the insertion portion 15 and a tubular portion 23 extended from the flange portion 7 toward the outside of the housing member. The insertion portion 15 has insertion holes 25 which communicate with the holding portion 11 and the tubular portion 23, and through which lead wires 31 of the thermistor body 5, described later, can be inserted. The insertion portion 15 has a lead wire exposure portion 27 which communicates with the insertion holes 25 and exposes the lead wires 31 inserted into the insertion holes 25 to the outside. By disposing the lead wire exposure portion 27 in the lead-out portion 13, the lead wires 31 can directly contact air inside the housing member, and it is possible to approximate a temperature of the lead wires 31 to a temperature inside the housing member. The lead wires 31 inserted into the insertion holes 25 are disposed in the tubular portion 23. The tubular portion 23 can be fitted to a connector (not illustrated) electrically connected to a controller (not illustrated) for controlling each mechanism mounted in a vehicle, for example. By fitting the connector to the tubular portion 23, a temperature inside the housing member detected by the thermistor body 5 is input to the controller.

As illustrated in FIGS. 1 to 5, the thermistor body 5 is assembled to the holding member 3 before the holding member 3 is assembled to the housing member. The thermistor body 5 includes a thermistor element 29, the lead wires 31, and the resin portion 33.

The thermistor element 29 is constituted by an electronic component of which resistance changes due to temperature changes, for example. The thermistor element 29 is arranged inside the housing member and detects a temperature inside the housing member while the holding member 3 is assembled to the housing member.

Each lead wire 31 is made from a conductive material, and one end of each lead wire 31 is electrically connected to the thermistor element 29. A plurality of lead wires 31 (in this case, two lead wires) are disposed for the thermistor element 29. The other end of each of the lead wires 31 is inserted into respective insertion hole 25 of the insertion portion 15, and arranged inside the tubular portion 23, while the thermistor body 5 is assembled to the holding member 3. Each of the lead wires 31 has one end arranged inside the housing member, and the other end arranged outside the housing member while the holding member 3 is assembled to the housing member. Each of the lead wires 31 is electrically connected to the controller via the connector by fitting the connector to the tubular portion 23.

The resin portion 33 is made from an epoxy resin as an insulating material having more excellent heat transfer properties than those of a PP resin. The resin portion 33 is insert molded in a rectangular parallelepiped shape so as to cover the thermistor element 29 and lead the lead wires 31 to the outside. The resin portion 33 is housed in the holding portion 11, and due to the resin portion 33 being engaged with the holding piece 19, the resin portion 33 causes the holding member 3 to hold the thermistor body 5 while the thermistor body 5 is assembled to the holding member 3. The resin portion 33 is arranged inside the housing member, and causes the thermistor element 29 to be arranged inside the housing member while the holding member 3 is assembled to the housing member.

Since each of the lead wires 31 leads to the outside from the resin portion 33, only the holding member 3 (insertion portion 15) is arranged in a periphery of the lead wires 31 located inside the housing member. Therefore, heat inside the housing member is easily transferred to the lead wires 31, and a temperature of each of the lead wires 31 approximates a temperature inside the housing member. Since the temperature of each of the lead wires 31 approximates the temperature inside the housing member, it is possible to suppress an influence on a detection temperature of the thermistor element 29 electrically connected to each of the lead wires 31. This can enhance the detection accuracy of a temperature detected by the thermistor element 29. In addition, since the resin portion 33 is made from an epoxy resin having excellent heat transfer properties, heat inside the housing member is easily transferred to the thermistor element 29, and the detection accuracy of a temperature by the thermistor element 29 can be enhanced.

The thermistor body 5 is assembled to the holding member 3 by inserting a tip of each of the lead wires 31 into respective insertion hole 25 from the holding portion 11 side of the holding member 3 before the holding member 3 is assembled to the housing member. The insertion of the thermistor body 5 into the holding member 3 is completed by abutting the resin portion 33 and a top surface of the insertion portion 15, and abutting a stepped portion of each lead wire 31 and a stepped portion of respective insertion hole 25. At this point, the holding piece 19 of the holding portion 11 is engaged with the resin portion 33, and the thermistor body 5 is held by the holding member 3.

This kind of thermistor 1 includes the holding member 3 assembled on the wall portion separating the inside and the outside of the housing member, and the thermistor body 5 which is held by the holding member 3 and detects a temperature inside the housing member. Further, the thermistor body 5 includes the thermistor element 29 for detecting a temperature, the lead wires 31 electrically connected to the thermistor element 29, and the resin portion 33 which covers the thermistor element 29 and from which the lead wires 31 lead to the outside. Still further, the holding member 3 has the holding portion 11 which holds the resin portion 33 and arranges the thermistor element 29 inside the housing member, and the lead-out portion 13 which leads the lead wires 31 to the outside of the housing member.

Since the lead wires 31 lead to the outside from the resin portion 33 held by the holding portion 11, only the holding member 3 is arranged in a periphery of each lead wire 31 located inside the housing member. Therefore, heat inside the housing member is easily transferred to the lead wires 31, and a temperature of the lead wires 31 approximates a temperature inside the housing member. If the temperature of the lead wires 31 approximates the temperature inside the housing member, it is possible to suppress an influence on a detection temperature by the thermistor element 29 electrically connected to the lead wires 31.

This can enhance the detection accuracy by this kind of thermistor 1.

Further, the holding portion 11 has the resin exposure portions 21 for exposing the resin portion 33 to the inside of the housing member.

Therefore, the resin exposure portions 21 enables the resin portion 33 to directly contact the air inside the housing member, and this can enhance the temperature detection accuracy by the thermistor body 5.

Further, the lead wire exposure portion 27 for exposing the lead wires 31 to the inside of the housing member is disposed in the lead-out portion 13.

Therefore, the lead wire exposure portion 27 enables the lead wires 31 to directly contact air inside the housing member, and this can approximate a temperature of the lead wires 31 to a temperature inside the housing member.

Further, the resin portion 33 is made from an epoxy resin.

Therefore, heat inside the housing member can be easily transferred to the thermistor element 29 arranged inside the resin portion 33 by means of the epoxy resin having excellent heat transfer properties, and the temperature detection accuracy by the thermistor element 29 can be enhanced.

Although the present embodiment has been described above, the present embodiment is not limited thereto, and various modifications can be made within the scope of the gist of the present embodiment.

Although the number of lead wires is two in the above description, the number is not limited thereto, and the number of lead wires may be three or more, for example.

1. A thermistor, comprising:
a holding member that is assembled on a wall portion of a housing member, the wall portion separating an inside and an outside of the housing member; and
a thermistor body that is held by the holding member and that detects a temperature inside the housing member, wherein
the thermistor body comprises:
a thermistor element that detects the temperature;
a lead wire that is electrically connected to the thermistor element; and
a resin portion which covers the thermistor element and from which the lead wire leads to an outside portion, and
the holding member comprises:
a holding portion that holds the resin portion and arranges the thermistor element inside the housing member; and
a lead-out portion that leads the lead wire to the outside of the housing member.

2. The thermistor according to claim 1, wherein the holding portion comprises a resin exposure portion that exposes the resin portion to the inside of the housing member.

3. The thermistor according to claim 1, wherein the lead-out portion comprises a lead wire exposure portion that exposes the lead wire to the inside of the housing member.

4. The thermistor according to claim 1, wherein the resin portion is made from an epoxy resin.
